(19) United States
(12) Patent Application Publication
(10) Pub. No.: US 2026/0155891 A1
(43) Pub. Date: Jun. 4, 2026

(54) ESTIMATION APPARATUS, NODE APPARATUS, ESTIMATION METHOD, OPTICAL NETWORK SYSTEM, AND RECORDING MEDIUM

(71) Applicant: NEC Corporation, Tokyo (JP)

(72) Inventor: Shigeyuki YANAGIMACHI, Tokyo (JP)

(73) Assignee: NEC Corporation, Tokyo (JP)

(21) Appl. No.: 19/372,464

(22) Filed: Oct. 29, 2025

(30) Foreign Application Priority Data
Dec. 4, 2024 (JP) 2024-211179

(51) Int. Cl. H04B 10/291; H04B 10/073

(52) U.S. Cl. CPC H04B 10/2916; H04B 10/0731

(57) ABSTRACT

An estimation apparatus that estimates a Raman tilt of an optical transmission line in an all-photonics network, the estimation apparatus including an acquisition unit for acquiring a use state of each use wavelength in the optical transmission line and optical power of each use wavelength at an outlet of an adjacent node of the optical transmission line, a determination unit for determining the number of divisions, and a Raman tilt calculation unit for estimating the Raman tilt by using an integral expression in which each of subbands obtained by dividing an entire use band into the number of divisions is an integration step, the subbands having, as parameters, a use state of each use wavelength, optical power of each use wavelength, a loss coefficient determined by a fiber type of the optical transmission line, a link distance defining a distance between adjacent nodes, and a Raman coefficient.

This application is based upon and claims the benefit of priority from Japanese patent application No. 2024-211179, filed on Dec. 4, 2024, the disclosure of which is incorporated herein in its entirety by reference.

### TECHNICAL FIELD

The present disclosure relates to a Raman tilt estimation apparatus, a node apparatus, an estimation method, an optical network system, and a program in multiband optical transmission.

### BACKGROUND ART

In recent years, traffic flowing through a network continues to increase rapidly due to the rapid spread of mobile terminals typified by smartphones and large-capacity data communication such as high-definition images due to the advancement of terminals. According to a survey, total download traffic of broadband subscribers in Japan has been increasing at a rate of about 23% per year at about 29.2 Tbps in 2022, and traffic is expected to increase in the future. Meanwhile, in core networks that support large-capacity communication, technologies have been developed to meet the need for large capacity, such as wavelength division multiplexing (WDM) in which optical signals of a plurality of different wavelengths are multiplexed and transmitted on one optical fiber, and advanced modulation methods such as dual polarization differential quadra-ture phasa shift keying (DP-QPSK) and 16-quadrature amplitude modulation (16-QAM).

Furthermore, with the progress of 5G services in wireless communication, there is an increasing need not only for a large capacity but also for a low network delay. In response to these needs, in recent years, in an innovative optical and wireless network (IWON) concept led by NTT, an all-photonics network that achieves a large-capacity and low-delay NW has been proposed. All-photonics networks, unlike networks with electrical conversion in conventional switching nodes, transmit as optical on all paths. Therefore, not only communication with a large capacity can be performed without being bound by the capacity of the electric switch, but also a delay associated with electric conversion does not occur, and a delay can be reduced.

However, when the wavelength path is used in the communication unit as described above, a problem of wavelength resources occurs. Currently, a wavelength band mainly used is a C band, and a wavelength resource is about 100 nm. Meanwhile, a method using an L band and spatial multiplexing transmission having a plurality of cores in one fiber have been studied. In spatial multiplexing transmission, an optical fiber for spatial multiplexing communication, an optical amplifier for spatial multiplexing that compensates for a transmission loss, and the like have been studied. However, since a device is in a development stage, and rerouting a new transmission path leads to an increase in cost, it is currently regarded as a future technology. The L band expansion is a realistic solution because fibers and devices have already been developed and current transmission paths are available. However, multiband transmission of the C+L band is strongly affected by Raman tilt.

FIG. 12 is a conceptual diagram schematically illustrating Raman tilt. The Raman tilt is a phenomenon in which optical energy on a short wavelength side transitions to a long wavelength side due to stimulated Raman scattering which is a nonlinear phenomenon of light, and an inclination of power occurs. As a result, the signal quality on the short wavelength side is deteriorated. As compared with the single-band system of the C band, for example, in the multiband system of the C+L band, the power difference between the short wavelength side and the long wavelength side is further increased, and thus, a technique of measuring or estimating the Raman tilt to compensate for the inclination is required.

FIG. 13 illustrates an example of a conventionally proposed Raman tilt compensation method. The Raman tilt varies depending on the number of input wavelengths (total input power), the wavelength positional relationship, and the transmission distance. In the method of FIG. 13, not only the main optical signal for communication but also the dummy optical signal is input and transmitted at the full (all) wavelength, so that the difference in the Raman tilt due to the positional relationship between the number of input wavelengths (total input power) and the wavelength is eliminated. As a result, the difference between the Raman tilts can be reduced only depending on the transmission distance.

If the transmission distance between the nodes is constant, the Raman tilt after the inter-node transmission is determined to be one, and the Raman tilt can be compensated by performing equalization or the like at the node outlet. However, it is effective in a case where the number of wavelengths of the main signal is large, but there is a problem that wasteful energy is consumed in a case where the number of wavelengths of the main signal is small, that is, in a case where there are many dummy optical signals.

Meanwhile, a method of estimating and compensating for the Raman tilt by a predetermined arithmetic expression is disclosed. For example, JP 2023-108871 A discloses a method in which a maximum tilt amount (distance infinity or maximum number of wavelengths) is defined in advance, and a generated tilt amount (FiberSRS) for each transmission distance is estimated using the following expression according to input power and distance.

$$FiberSRS = \sum [ {SRScoeff}_{Fibertype} \times ( \frac{{FiberLossCoeff}_{base}}{{FiberLossCoeff}_{actual}} ) \times [ 1 - {10}^{- ( \frac{FiberLoss}{10} )} ] \times FiberInput ] \qquad [ Expression 1 ]$$

JP 2008-42096 A discloses a method of approximating the inclination of the Raman tilt from the approximate second order approximation of the fiber loss using the following expression and estimating the inclination amount (SRS inclination amount Stilt) as the gain inclination by multiplying the inclination amount by the input power.

$$a = A * α {sig}^{⋀} 2 + B * α sig + C \qquad [ Expression 2 ]$$

$$Stilt = a * Pin$$

However, in JP 2023-108871 A and JP 2008-42096 A, since the positional relationship of wavelengths is not considered, for example, in a case where main signals are dispersedly arranged, it is considered that an error increases. As a highly accurate estimation method, a Split-Step Fourier Method represented by the following expression is disclosed in Daniel Francis Semrau, “Physical Layer Modelling of Optical Fibre Communication Systems in the Nonlinear Regime”, Optical Networks Group Department of Electronic & Electrical Engineering University College London (2020).

$$\frac{\partial Q}{\partial z} = - \frac{α}{2} Q + j γ ( {\vert Q \vert}^{2} Q - {T}_{R} \frac{\partial {\vert Q \vert}^{2}}{\partial T} Q ) . \qquad [ Expression 3 ]$$

However, since this method is a method of analytically solving a differential equation, the calculation amount is large. Therefore, the calculation is not in time in a network in which there are many path fluctuations in which it is necessary to quickly estimate the Raman tilt.

Daniel Francis Semrau, “Physical Layer Modelling of Optical Fibre Communication Systems in the Nonlinear Regime”, Optical Networks Group Department of Electronic & Electrical Engineering University College London (2020) discloses an integral form with GN model represented by the following expression.

$$G ( f ) = \frac{16}{27} {γ}^{2} \int {df}_{1} \int {df}_{2} {G}_{Tx} ( {f}_{1} ) {G}_{Tx} ( {f}_{2} ) {G}_{Tx} ( {f}_{1} + {f}_{2} - f ) \cdot {\vert {\int }_{0}^{L} d ζ \frac{{P}_{tot} {e}^{- αζ - {P}_{tot} {C}_{r} {L}_{eff} ( {f}_{1} + {f}_{2} - f )}}{\int {G}_{Tx} ( v ) {e}^{- {P}_{tot} {C}_{r} {L}_{eff} v} dv} {e}^{j ϕ ( {f}_{1} , {f}_{2} , f , ζ )} \vert}^{2} . \qquad [ Expression 4 ]$$

This method can reduce the calculation amount as compared with the Split-Step Fourier Method, but the calculation is not in time in a network in which there are many path fluctuations in which it is necessary to quickly estimate the Raman tilt.

### SUMMARY

A first problem is that, in the conventional method of estimating and compensating the Raman tilt in the multiband optical transmission using, for example, the C+L band, the power consumption greatly increases. The reason is that a large number of dummy optical signals are required in addition to the main optical signal because the entire use band is fully filled using the dummy optical signal and the Raman tilt is determined and compensated in all links.

A second problem is that, for example, in multiband optical transmission using a C+L band, accuracy may be insufficient in a conventional method of estimating and compensating for a Raman tilt. This is because in the Raman tilt estimation methods described in JP 2023-108871 A and JP 2008-42096 A, the positional relationship of wavelengths is not accounted for.

A third problem is that, for example, in multiband optical transmission using a C+L band, a conventional method for estimating and compensating Raman tilt cannot perform quick estimation and compensation. This is because the integral form with GN model method described in Daniel Francis Semrau, “Physical Layer Modelling of Optical Fibre Communication Systems in the Nonlinear Regime”, Optical Networks Group Department of Electronic & Electrical Engineering University College London (2020) requires a huge calculation amount.

It is an object of the present disclosure to solve the above problems and provide a network technology capable of faster Raman tilt estimation and compensation.

An estimation apparatus according to one aspect of the present disclosure is an estimation apparatus that estimates a Raman tilt of an optical transmission line in an all-photonics network, the estimation apparatus including: an acquisition means for acquiring a use state of each use wavelength in the optical transmission line and optical power of each use wavelength at an outlet of an adjacent node of the optical transmission line; a determination means for determining the number of divisions; and a Raman tilt calculation means for estimating the Raman tilt by using an integral expression in which each of subbands obtained by dividing an entire use band into the number of divisions is an integration step, the subbands having, as parameters, a use state of each use wavelength, optical power of each use wavelength, a loss coefficient determined by a fiber type of the optical transmission line, a link distance defining a distance between adjacent nodes, and a Raman coefficient.

A node apparatus according to one aspect of the present disclosure includes the estimation apparatus described above; an optical transmission line that transmits an optical signal from an adjacent node; an optical amplifier that is connected to the optical transmission line and amplifies the optical signal; an equalizer that is connected to the optical amplifier and corrects the optical signal; a tap coupler that extracts a part of optical output of the equalizer; an optical switch that is connected to the equalizer and switches a path of the optical signal; an optical transceiver that is connected to the optical switch and adds/drops a client signal to/from the optical switch; and a device controller that controls the optical amplifier, the equalizer, the tap coupler, the optical switch, and the optical transceiver.

An information processing method according to one aspect of the present disclosure is an estimation method for estimating a Raman tilt of an optical transmission line in an all-photonics network, the estimation method including: acquiring a use state of each use wavelength in the optical transmission line and optical power of each use wavelength at an outlet of an adjacent node of the optical transmission line; determining the number of divisions; and estimating the Raman tilt by using an integral expression in which each of subbands obtained by dividing an entire use band into the number of divisions is an integration step, the subbands having, as parameters, a use state of each use wavelength, optical power of each use wavelength, a loss coefficient determined by a fiber type of the optical transmission line, a link distance defining a distance between adjacent nodes, and a Raman coefficient.

An optical network system according to one aspect of the present disclosure includes a plurality of the node apparatuses, and controls the plurality of node apparatuses.

A program according to one aspect of the present disclosure is a program for causing a computer to function as the estimation apparatus, and causes the computer to function as the acquisition means, the determination means, and the Raman tilt calculation means.

According to the present disclosure, it is possible to provide a network technology capable of faster Raman tilt estimation and compensation.

### BRIEF DESCRIPTION OF THE DRAWINGS

FIG. 1 is a block diagram illustrating a configuration of an estimation apparatus according to the present disclosure;

FIG. 2 is a flowchart illustrating a flow of an estimation method according to the present disclosure;

FIG. 3 is a block diagram illustrating a configuration of a node apparatus according to the present disclosure;

FIG. 4 is a block diagram illustrating a configuration of an estimation apparatus according to the present disclosure;

FIG. 5 is a flowchart illustrating a flow of a compensation method according to the present disclosure;

FIG. 6A and FIG. 6B are conceptual diagrams illustrating a state in which a use band is divided into a plurality of subbands;

FIG. 7 is a block diagram illustrating a configuration of a node apparatus according to the present disclosure;

FIG. 8 is a flowchart illustrating a configuration of an estimation apparatus according to the present disclosure;

FIG. 9 is a flowchart illustrating a flow of a compensation method according to the present disclosure;

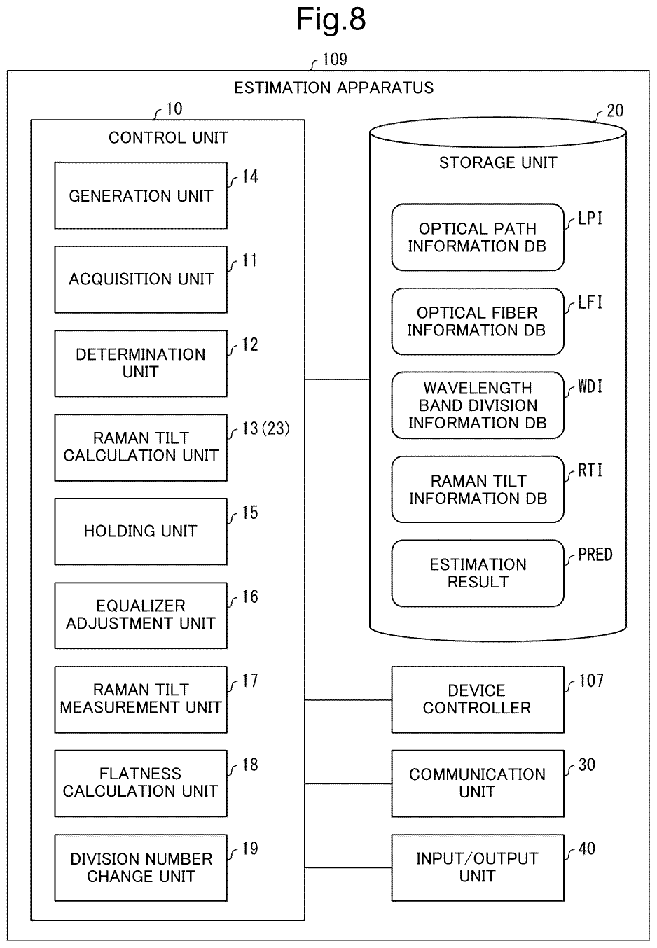

FIG. 10 is a block diagram illustrating a configuration of an optical network according to the present disclosure;

FIG. 11 is a block diagram illustrating a hardware configuration of the estimation apparatus according to the present disclosure;

FIG. 12 is a conceptual diagram schematically illustrating Raman tilt; and

FIG. 13 is a conceptual diagram schematically illustrating Raman tilt compensation according to a conventional technique.

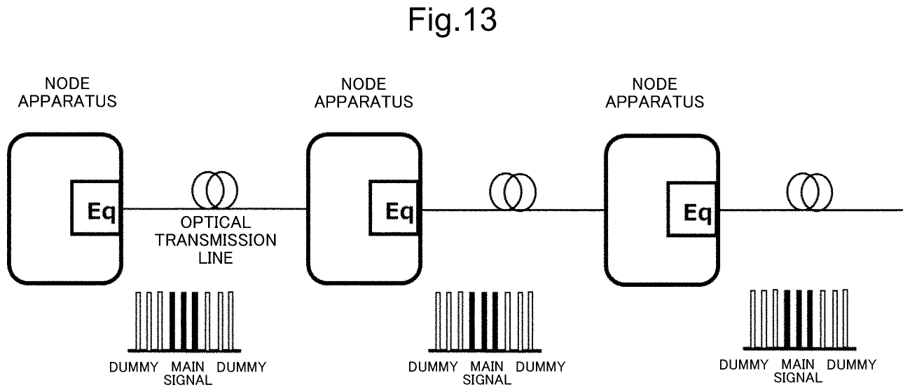

### EXAMPLE EMBODIMENT

Hereinafter, example embodiments of the present disclosure will be exemplified. However, the present disclosure is not limited to the exemplary example embodiments described below, and various modifications can be made within the scope described in the claims. For example, example embodiments obtained by appropriately combining the techniques (some or all of the products or methods) adopted in the following exemplary example embodiments can also be included in the scope of the present disclosure. Example embodiments obtained by appropriately omitting some of the techniques adopted in the following exemplary example embodiments can also be included in the scope of the present disclosure. The effects mentioned in the following exemplary example embodiments are examples of effects expected in the exemplary example embodiments, and do not define the extension of the present disclosure. That is, example embodiments that do not achieve the effects mentioned in the following exemplary example embodiments can also be included in the scope of the present disclosure.

### First Example Embodiment

A first exemplary example embodiment that is an example of an example embodiment of the present disclosure will be described in detail with reference to the drawings. The present exemplary example embodiment is a basic form of each exemplary example embodiment described below. The application range of each technique adopted in the present exemplary example embodiment is not limited to the present exemplary example embodiment. That is, each technique adopted in the present exemplary example embodiment can also be adopted in other exemplary example embodiments included in the present disclosure as long as no particular technical problem occurs. Each technique illustrated in the drawings referred to for explaining the present exemplary example embodiment can also be employed in other exemplary example embodiments included in the present disclosure as long as no particular technical problem occurs.

### (Configuration of Estimation Apparatus 1)

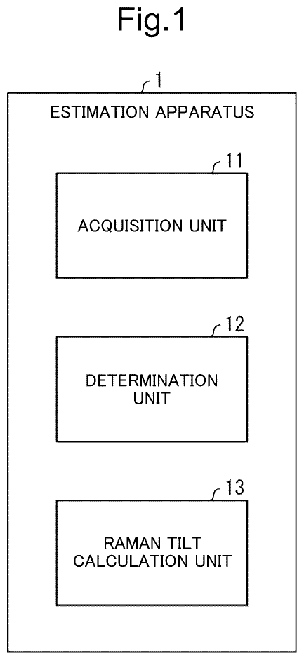

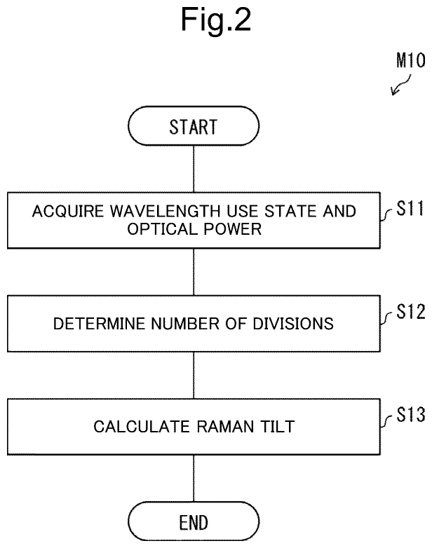

A configuration of an estimation apparatus 1 according to the present exemplary example embodiment will be described with reference to FIG. 1. FIG. 2 is a block diagram illustrating a configuration of the estimation apparatus 1. The estimation apparatus 1 is an apparatus that estimates a Raman tilt of an optical transmission line in an all-photonics (optical communication) network, and includes an acquisition unit (means) 11, a determination unit (means) 12, and a Raman tilt calculation unit (means) 13 as illustrated in FIG. 1.

### (Acquisition Unit 11)

The acquisition unit 11 acquires each wavelength use state in the optical transmission line and optical power of each use wavelength at an outlet of an adjacent node of the optical transmission line. Here, the wavelength use state is a wavelength band used when optical communication is performed. Optical communication is a communication method for transmitting a signal using light, and for example, an optical fiber is used as a transmission path. Therefore, it is necessary to consider transmission loss of an optical fiber and the like, and thus, in optical communication, a very small wavelength band of 1000 to 1675 nm among wavelengths of electromagnetic waves is used.

Further, within this wavelength band, subdivisions are made, which are respectively called, from the shorter wavelength side, a T band (Thousand-band) (1000 to 1260 nm), an O band (Original-band) (1260 to 1360 nm), an E band (Extended-band) (1360 to 1460 nm), an S band (Short-wavelength-band) (1460 to 1530 nm), a C band (Conventional-band) (1530 to 1565 nm), an L band (Long-wavelength-band) (1565 to 1625 nm), and a U band (Ultralong-wavelength-band) (1625 to 1675 nm). The acquisition unit 11 can acquire a status of which band is being used among these bands. As an example, the acquisition unit 11 may acquire the statuses of the C band and the L band that are strongly affected by the Raman tilt.

Optical power at each use wavelength (each band) is acquired at an adjacent node outlet of an optical transmission line to be described later (that is, as the input optical power to the estimation apparatus). Optical power refers to the amount of optical energy per unit time and is usually measured in Watts (W).

### (Determination Unit 12)

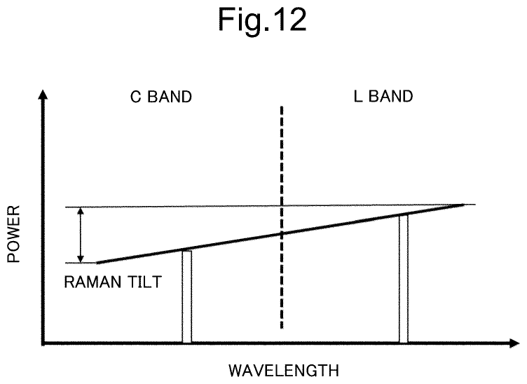

The determination unit 12 determines the number of divisions. The present disclosure considers the characteristic that the power transition due to Raman tilt increases substantially linearly from the short wavelength side to the long wavelength side (see FIG. 12). Based on this linear characteristic, power transition between adjacent channels is small. For example, assuming that a power transition from a shortest wavelength that is minimum to a longest wavelength that is maximum in one band is 2 dBm, and this one band is 100 channels, the power transition in the adjacent channel is 0.02 dB.

In the present disclosure, in consideration of this linear characteristic, in the calculation of the integral expression for estimating the Raman tilt, a subband obtained by dividing the entire use band into the number of divisions is calculated as an integration step, thereby improving calculation efficiency. The method for determining the number of divisions is not particularly limited, but for example, the determination unit 12 may determine the number of divisions to be used by acquiring the number of divisions from a database in which the previously input number of divisions is stored.

### (Raman Tilt Calculation Unit 13)

The Raman tilt calculation unit 13 estimates (calculates) the Raman tilt by using an integral expression in which each of subbands obtained by dividing the entire use band into the number of divisions is an integration step, the subbands having, as parameters, a use state of each of the use wavelengths, optical power of each of the use wavelengths, a loss coefficient determined by a fiber type of the optical transmission line, a link distance defining a distance between adjacent nodes, and a Raman coefficient.

Here, the fiber type of the optical transmission line is, for example, a difference in material and structure of the optical fiber, such as a multi-mode fiber adopting a large-diameter core that allows a plurality of light modes to pass, an SI type in which light travels while being reflected by a clad and a refractive index of light inside the core is always constant, a GI type in which a refractive index of light continuously changes, or a single mode fiber in which a core diameter of an SI type multi-mode fiber is reduced. The magnitude (loss coefficient) of the transmission loss is determined by the difference in these materials and structures.

As the integral expression, the above-described Expression (4) is used. This expression is a Gaussian noise model (GN model described above) that performs propagation estimation in a short-range transmission path in consideration of not only propagation path characteristics including ASE noise and a fiber nonlinear optical effect but also transceiver characteristics, and G (f) is a power spectrum density (Ws) of a nonlinear interface relevant to a wavelength (horizontal axis) and power (vertical axis) in FIG. 12.

Furthermore, a link distance L (propagation distance, for example, 100 km) that defines a distance between adjacent nodes is used. The link distance L corresponds to an integration section on the side to which Expression (4) is applied. The Raman coefficient is a plurality of coefficients existing in Expression (4), and refers to an NL coefficient γ (for example, 0.2 dB/km), an attenuation (loss) coefficient α (for example, 0.2 dB/km), a Raman gain Cr (for example, 0.4 [l/W/Km]), and the like. Pₜₒₜ is the total light intensity, ζ is a function of the integral variable, and Left (C) is the effective length (1−exp(−αζ))/α.

Conventionally, Expression (4) is calculated by dividing the entire calculation wavelength band into infinitesimal sections (df₁, df₂). However, in the present disclosure, the entire calculation wavelength band is calculated by dividing the entire calculation wavelength band into finite sections (each of a plurality of subbands is used as an integration step), so that the calculation amount can be greatly reduced.

### (Effects of Estimation Apparatus 1)

As described above, in the estimation apparatus 1,
a configuration is adopted that includes:
   acquiring each wavelength use state in the optical transmission line and optical power of each use wavelength at an outlet of an adjacent node of the optical transmission line;
   determining the number of divisions; and
   estimating the Raman tilt by using an integral expression in which each of subbands obtained by dividing an entire use band into the number of divisions is an integration step, the subbands having, as parameters, a use state of each of the use wavelengths, optical power of each of the use wavelengths, a loss coefficient determined by a fiber type of the optical transmission line, a link distance defining a distance between adjacent nodes, and a Raman coefficient.

As described above, in the estimation apparatus 1, a configuration is adopted that includes
estimating the Raman tilt by using an integral expression in which each of subbands obtained by dividing the entire use band into the number of divisions is an integration step.

Therefore, the entire calculation wavelength band in the integral Expression (4) can be calculated by being divided into finite sections (each of the plurality of subbands is used as an integration step), and the calculation amount can be greatly reduced. Since the calculation amount can be reduced, power consumption is also suppressed.

### (Flow of Estimation Method M10)

Next, a flow of the estimation method M10 according to the present exemplary example embodiment will be described with reference to FIG. 2. FIG. 2 is a flowchart illustrating a flow of the estimation method M10. The estimation method M10 estimates the Raman tilt of the optical transmission line in the all-photonics network, and includes, as illustrated in FIG. 2, step S11 of acquiring each wavelength use state and optical power, step S12 of determining the number of divisions, and step S13 of calculating (estimating) the Raman tilt.

### (Step S11)

In step S11, the acquisition unit 11 acquires each wavelength use state in the optical transmission line and optical power of each use wavelength at an outlet of an adjacent node of the optical transmission line. Since a more specific description of the acquisition unit 11 has been described above, the description thereof will be omitted here.

### (Step S12)

In step S12, the determination unit 12 determines the number of divisions. Since a more specific description of the determination unit 12 has been described above, the description thereof will be omitted here.

### (Step S13)

Subsequently, in step S13, the Raman tilt calculation unit 13 estimates (calculates) the Raman tilt by using an integral expression in which each of subbands obtained by dividing the entire use band into the number of divisions is an integration step, the subbands having, as parameters, a use state of each of the use wavelengths, optical power of each of the use wavelengths, a loss coefficient determined by a fiber type of the optical transmission line, a link distance defining a distance between adjacent nodes, and a Raman coefficient. Since a more specific description of the Raman tilt calculation unit 13 has been described above, the description thereof is omitted here.

As described above, in the estimation method M10,
a configuration is adopted that includes:
   acquiring a use state of each use wavelength in the optical transmission line and optical power of each use wavelength at an outlet of an adjacent node of the optical transmission line;
   determining the number of divisions; and
   estimating the Raman tilt by using an integral expression in which each of subbands obtained by dividing an entire use band into the number of divisions is an integration step, the subbands having, as parameters, a use state of each of the use wavelengths, optical power of each of the use wavelengths, a loss coefficient determined by a fiber type of the optical transmission line, a link distance defining a distance between adjacent nodes, and a Raman coefficient. According to the above configuration, effects similar to those of the estimation apparatus 1 are obtained.

### Second Example Embodiment

A second exemplary example embodiment which is an example of an example embodiment of the present disclosure will be described in detail with reference to the drawings. Components having the same functions as the components described in the above-described exemplary example embodiments are denoted by the same reference signs, and the description thereof will be appropriately omitted. The application range of each technique adopted in the present exemplary example embodiment is not limited to the present exemplary example embodiment. That is, each technique adopted in the present exemplary example embodiment can also be adopted in other exemplary example embodiments included in the present disclosure as long as no particular technical problem occurs. Each technique illustrated in each drawing referred to for explaining the present exemplary example embodiment can also be employed in other exemplary example embodiments included in the present disclosure as long as no particular technical problem occurs.

### (Configuration of Node Apparatus 101)

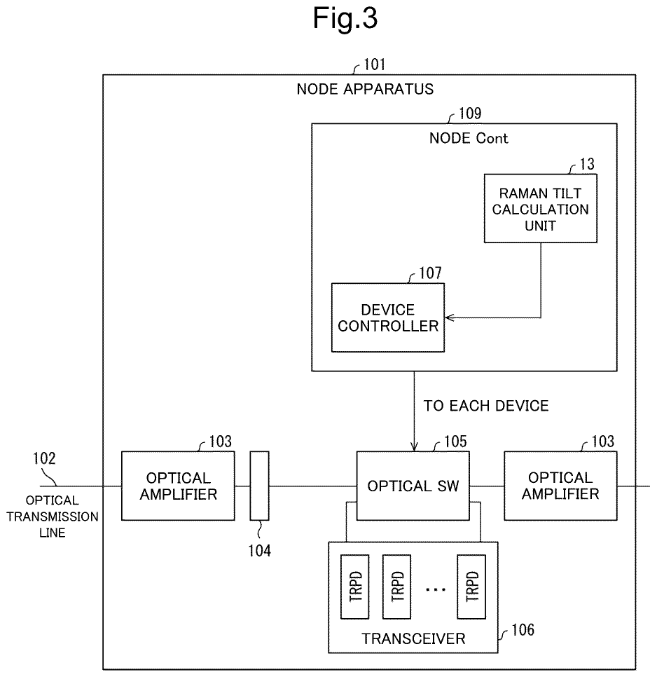

A configuration of the node apparatus 101 according to the present exemplary example embodiment will be described with reference to FIG. 3. The node apparatus 101 switches an optical path in an optical network. FIG. 3 is a block diagram illustrating a configuration of the node apparatus 101. As illustrated in FIG. 3, the node apparatus 101 includes an estimation apparatus 109, an optical transmission line 102 that transmits an optical signal from an adjacent node to be described later, an optical amplifier 103 that is connected to the optical transmission line 102 and amplifies the optical signal (input optical signal), an equalizer 104 that is connected to the optical amplifier 103 and corrects the optical signal, an optical switch 105 that is connected to the equalizer 104 and switches a path of the optical signal, an optical transceiver 106 that is connected to the optical switch 105 and adds/drops a client (not illustrated) signal to/from the optical switch 105, and an optical amplifier 103 that amplifies an optical signal whose path has been switched by the optical switch 105. The estimation apparatus 109 further includes a device controller 107 for controlling the optical amplifier 103, the equalizer 104, the optical switch 105, and the optical transceiver 106 in the node apparatus 101.

The optical switch 105 is a device mainly used in optical communication, and branches a specific signal or switches a destination as an optical signal without being converted into an electric signal. The optical transceiver 106 is used to receive a signal through the optical transmission line 102. Usually, the optical amplifier 103 or a photodiode (not illustrated) is mounted on the receiver, and generates a logic compatible output.

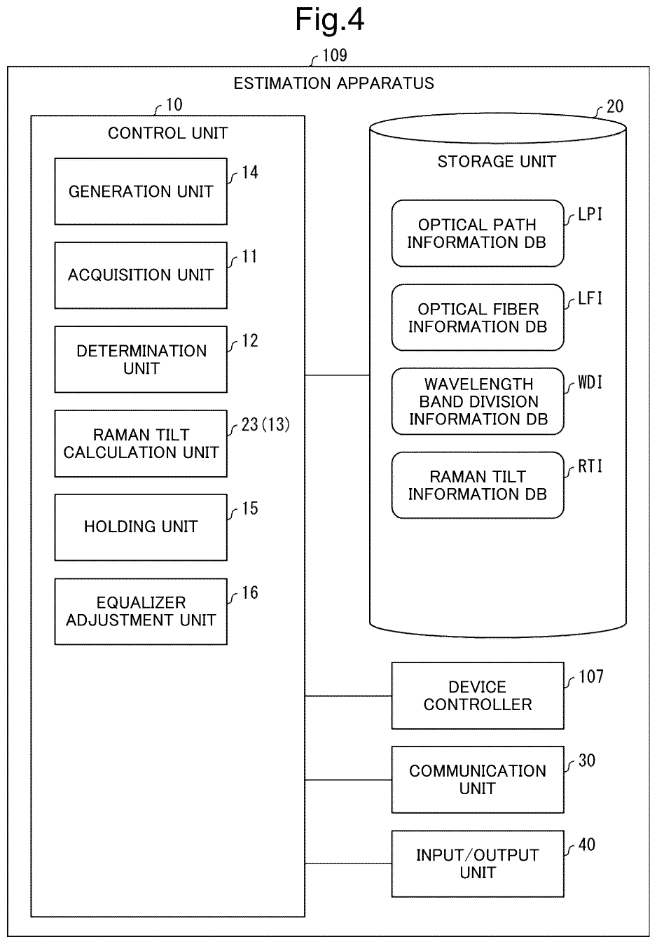

Next, a configuration of the estimation apparatus 109 will be described in detail with reference to FIG. 4. The estimation apparatus 109 includes a control unit 10, a storage unit 20, a communication unit 30, an input/output unit 40, and the device controller 107.

The node apparatus 101 is a next-generation optical node apparatus capable of achieving both an increase in the reach distance of the optical path (path of the optical signal) and an increase in the communication capacity. The apparatus 101 achieves improvement in robustness of a next-generation ultra-high-capacity optical network by effectively utilizing a network. The optical node apparatus 101, which is a path switching apparatus for communication, widens the bandwidth by optical filtering and greatly reduces band narrowing that reduces the reach distance. The optical signal passing through the optical filter having a wide band is controlled with high accuracy to suppress the loss of the signal and improve the reach distance of the optical path. Furthermore, in a network controller that centrally controls communication, allocation of a guard band (blank band) set to an optical signal to be transmitted is controlled, and the number of optical paths is increased in a limited band.

### (Communication Unit 30)

The communication unit 30 communicates with other node apparatuses and a network management system NMS 401 to be described later. The communication unit 30 transmits optical data supplied from another node apparatus or the NMS 401 to another node apparatus, or supplies data received by the node apparatus 101 to the storage unit 20.

### (Input/Output Unit 40)

The input/output unit 40 includes at least one of input/output apparatuses such as a keyboard, a mouse, a display, a printer, and a touch panel. Alternatively, input/output equipment such as a keyboard, a mouse, a display, a printer, and a touch panel may be connected to the input/output unit 40. In the case of this configuration, the input/output unit 40 receives inputs of various types of information to the estimation apparatus 109 from a connected tap coupler 301 (described later). The input/output unit 40 may output various types of information to the connected output equipment under the control of the control unit 10. Examples of the input/output unit 40 include an interface such as a universal serial bus (USB).

### (Storage Unit 20)

The storage unit 20 stores various data referred to by the control unit 10 and various databases generated by the control unit 10. As one example, in the storage unit 20,
the following are constructed:
   an optical path information database LPI that holds each wavelength use state in the optical transmission line 102 and optical power of each use wavelength at an outlet of an adjacent node;
   an optical fiber information database LFI that holds a fiber type of the optical transmission line 102, a loss coefficient determined for each fiber type, a link distance defining a distance between adjacent nodes, and a Raman coefficient;
   a wavelength band division database WDI that holds the number of divisions for dividing the entire use band (for example, the entire C+L band) into a plurality of subbands; and
   the Raman tilt database RTI that holds the estimated Raman tilt calculated by the Raman tilt calculation unit 23 that estimates the Raman tilt using Expression (4) from the information of the optical path information database LPI, the optical fiber information database LFI, and the wavelength band division database WDI. These databases may be of a cloud type outside the estimation apparatus 109.

The estimation result PRED is information indicating the latest estimation result derived by the Raman tilt calculation unit 23. Since a specific example of the estimation result PRED will be described later, description thereof is omitted here.

### (Control Unit 10)

As illustrated in FIG. 3, the control unit 10 includes a generation unit 14, the above-described acquisition unit 11, determination unit 12, and Raman tilt calculation unit 23, a holding unit 15, an equalizer adjustment unit 16, a Raman tilt measurement unit 17, a flatness calculation unit 18, and a division number change unit 19. Here, since the Raman tilt calculation unit 23 also has a function similar to the Raman tilt calculation unit 13 included in the estimation apparatus 1 described in the first exemplary example embodiment, the Raman tilt calculation unit 23 may be referred to as a Raman tilt calculation unit 23 (13).

### (Generation Unit 14)

The generation unit 14 generates a trigger for calculating the Raman tilt amount. This trigger is generated, for example, when the node apparatus 101 receives a command for performing Raman tilt calculation to be described later from the NMS 401 to be described later.

### (Acquisition Unit 11)

The acquisition unit 11 refers to the optical path information database LPI to acquire the wavelength use state in the optical transmission line 102 and the optical power of each use wavelength at the adjacent node outlet of the optical transmission line 102.

### (Determination Unit 12)

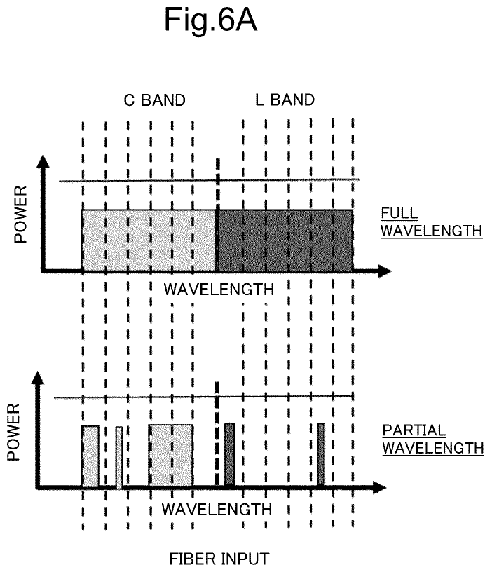

The determination unit 12 determines the number of divisions for dividing the entire use band into a plurality of subbands. Here, FIGS. 6A and 6B illustrate an example in which the entire use band (for example, the entire C+L band) is divided into a plurality of subbands.

FIG. 6A illustrates an example of optical fiber input. The upper diagram of FIG. 6A is a graph of the optical fiber input at the full wavelength input, and the lower diagram of FIG. 6A is a graph of the optical fiber input at a partial wavelength input.

FIG. 6B illustrates an example of optical fiber output after one span transmission with respect to the input illustrated in FIG. 6A. A upper diagram of FIG. 6B is a graph of an optical fiber output after one span transmission at the full wavelength input. A lower diagram of FIG. 6B is a graph of an optical fiber output after one span transmission at the partial wavelength input.

In this example, each of the C and L bands is divided into six subbands. Considering the characteristic that the power transition due to the Raman tilt increases substantially linearly from the short wavelength side to the long wavelength side, the power transition between adjacent channels is small. For example, assuming that the power transition from the shortest wave that is minimum to the longest wave that is maximum is 2 dbBm and the C band is 100 channels, the power transition in the adjacent channel is 0.02 dB. The number of divisions divided by the determination unit 12 is held in the wavelength band division database WDI.

### (Raman Tilt Calculation Unit 23)

The Raman tilt calculation unit 23 (13) performs the estimation calculation described above, but by applying the above characteristics, assuming that power is intensively arranged in the center channel (for example, the 51st channel) of the divided subbands, the Raman tilt may be calculated using Expression (4) for the central subband of the plurality of subbands, and the Raman tilt in the C band may be estimated. The L band is similarly calculated, or the Raman tilt at the minimum wavelength of the C band and the maximum wavelength of the L band is calculated, and the average of the two values may be taken, or the minimum Raman tilt and the maximum Raman tilt of each of the C band and the L band may be taken.

As a result, Expression (4) is calculated by dividing the entire calculation wavelength band into infinitesimal sections, but in the present disclosure, the Raman tilt is approximately calculated by focusing on the central subband among the divided subbands, and thus, it is possible to further greatly reduce the calculation amount.

### (Holding Unit 15)

The holding unit 15 holds the Raman tilt calculated by the Raman tilt calculation unit 23 in the Raman tilt information database RTI. Here, the Raman tilt information database RTI is, for example, a relational database including attribute information such as the above-described wavelength use state, optical power, fiber type, and loss coefficient for the calculated Raman tilt.

### (Equalizer Adjustment Unit 16)

The equalizer adjustment unit 16 corrects the power of the plurality of subbands based on the Raman tilt calculated by the Raman tilt calculation unit 23. Here, the equalizer adjustment unit 16 refers to the Raman tilt held in the Raman tilt information database RTI, and the device controller 107 controls the equalizer 104 based on the value, and adds light attenuation for each wavelength so that power is uniform over the entire use wavelength. The equalizer 104 is a compensation circuit that performs adjustment by a frequency filter in order to optimize the frequency characteristics of the electrical signal for information communication.

### (Effects of Node Apparatus 101)

As described above, in the estimation apparatus 1, in a case where a configuration is adopted that includes
a Raman tilt calculation unit calculating a Raman tilt for a central subband among the plurality of subbands,
it is possible to further greatly reduce the calculation amount.

Further, in the estimation apparatus 1,
when a configuration is adopted that further includes
   a holding unit for further holding the calculated Raman tilt,
and in the node apparatus 101, a configuration is adopted that includes:
   the above-described estimation apparatus;
   an optical transmission line that transmits an optical signal from an adjacent node;
   an optical amplifier that is connected to the optical transmission line and amplifies the optical signal;
   an equalizer that is connected to the optical amplifier and corrects the optical signal;
   an optical switch that is connected to the equalizer and switches a path of the optical signal;
   an optical transceiver that is connected to the optical switch and adds/drops a client signal to/from the optical switch; and
   a device controller that controls the optical amplifier, the equalizer, the optical switch, and the optical transceiver.

Further, in the node apparatus 101, a configuration is adopted that includes
an equalizer adjustment means for correcting power of the plurality of subbands based on Raman tilt calculated in the Raman tilt calculation means.

Therefore, under the above-described significantly reduced calculation, optical attenuation for each wavelength can be added so that power becomes uniform over the entire use wavelength band. In other words, faster Raman tilt estimation and compensation is possible.

### (Flow of Estimation Method M20)

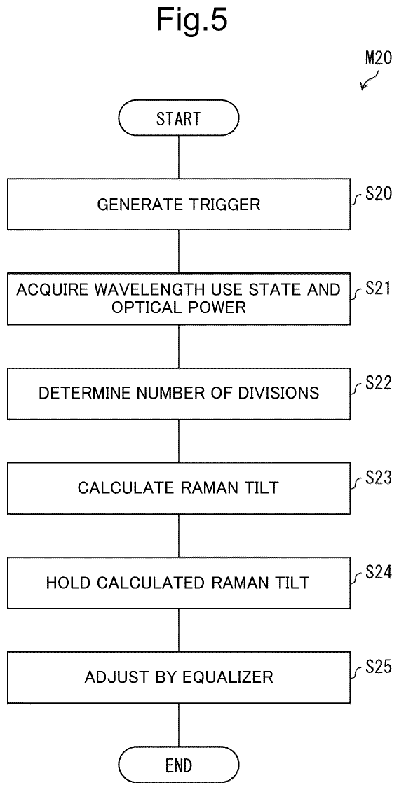

Next, a flow of the estimation method M20 according to the present exemplary example embodiment will be described with reference to FIG. 5. FIG. 5 is a flowchart illustrating a flow of the estimation method M20. The estimation method M20 includes a step S20 of generating a trigger, a step S21 of acquiring each wavelength use state and optical power, a step S22 of determining the number of divisions, a step S23 of calculating a Raman tilt, a step S24 of holding the calculated Raman tilt, and a step S25 of performing adjustment by an equalizer.

### (Step S20)

In step S20, the generation unit 14 generates a trigger for calculating the Raman tilt amount. Since a more specific description of the generation unit 14 has been described above, the description thereof will be omitted here.

### (Step S21)

In step S21, the acquisition unit 11 refers to the optical path information database LPI to acquire the wavelength use state in the optical transmission line 102 and the optical power of each use wavelength at the adjacent node outlet of the optical transmission line 102. Since a more specific description of the acquisition unit 11 has been described above, the description thereof will be omitted here.

### (Step S22)

In step S22, the determination unit 12 determines the number of divisions for dividing the entire use band into a plurality of subbands. Since a more specific description of the determination unit 12 has been described above, the description thereof will be omitted here.

### (Step S23)

In step S23, the Raman tilt calculation unit 23 performs the estimation calculation described above, or assumes that the power is intensively arranged in the center channel (for example, the 51st channel) of the divided subbands, and calculates the Raman tilt for the central subband of the plurality of subbands using Expression (4) to estimate the Raman tilt in the C band. Since a more specific description of the Raman tilt calculation unit 23 has been described above, the description thereof is omitted here.

### (Step S24)

In step S24, the holding unit 15 holds the Raman tilt calculated by the Raman tilt calculation unit 23 in the Raman tilt information database RTI. Since a more specific description of the holding unit 15 has been described above, the description thereof will be omitted here.

### (Step S25)

In step S25, the equalizer adjustment unit 16 corrects the power of the plurality of subbands based on the Raman tilt calculated by the Raman tilt calculation unit 23. Since the more specific description regarding the equalizer adjustment unit 16 has been described above, the description thereof will be omitted here.

As described above, in the estimation method M20, a configuration is adopted in which the power of the plurality of subbands is corrected based on the Raman tilt calculated in the Raman tilt calculation means. According to the above configuration, an effect similar to that of the node apparatus 101 is obtained.

### Third Example Embodiment

A third exemplary example embodiment which is an example of an example embodiment of the present disclosure will be described in detail with reference to the drawings. Components having the same functions as the components described in the above-described exemplary example embodiments are denoted by the same reference signs, and the description thereof will be appropriately omitted. The application range of each technique adopted in the present exemplary example embodiment is not limited to the present exemplary example embodiment. That is, each technique adopted in the present exemplary example embodiment can also be adopted in other exemplary example embodiments included in the present disclosure as long as no particular technical problem occurs. Each technique illustrated in each drawing referred to for explaining the present exemplary example embodiment can also be employed in other exemplary example embodiments included in the present disclosure as long as no particular technical problem occurs.

### (Configuration of Node Apparatus 101′)

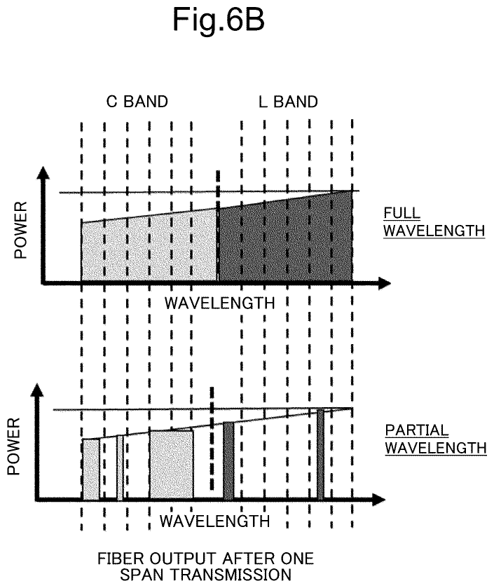

A configuration of a node apparatus 101′ according to the present exemplary example embodiment will be described with reference to FIG. 7. The node apparatus 101′ includes components (102 to 109) similar to those of the node apparatus 101 in FIG. 3, and the tap coupler 301 is additionally arranged between the output side of the equalizer 104 and the input side of the node apparatus 101′ and the optical switch 105. The tap coupler 301 extracts a part of the optical output of the equalizer 104. The tap coupler 301 is, for example, a polarization maintaining tap coupler, and is an optical passive element that branches the propagation light while maintaining the polarization of the input port. As a part of the optical output, for example, an optical output (power) at a band wavelength of a C band and an L band is extracted.

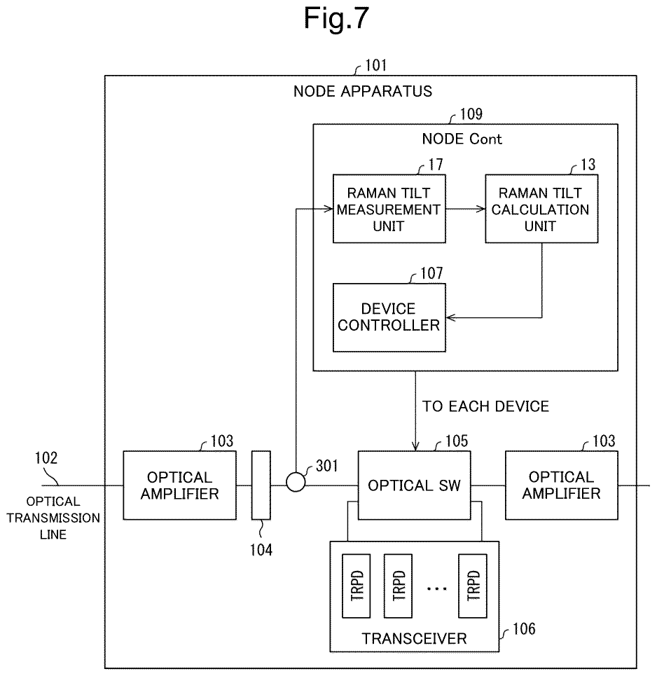

Next, a configuration of the estimation apparatus 109′ will be described in detail with reference to FIG. 8. The estimation apparatus 109′ includes the control unit 10, the storage unit 20, the communication unit 30, the input/output unit 40, and the device controller 107 similar to those of the estimation apparatus 109 in FIG. 4.

### (Control Unit 10)

As illustrated in FIG. 8, the control unit 10 further includes the Raman tilt measurement unit 17, the flatness calculation unit 18, and the division number change unit 19 in addition to the generation unit 14, the acquisition unit 11, the determination unit 12, and the Raman tilt calculation unit 13 (23), the holding unit 15, and the equalizer adjustment unit 16 described above. Here, since the Raman tilt calculation unit 13 also has a function similar to the Raman tilt calculation unit 23 included in the estimation apparatus 109 described in the second exemplary example embodiment, the Raman tilt calculation unit 13 may be referred to as a Raman tilt calculation unit 13 (23) or 23 (13).

### (Raman Tilt Measurement Unit 17)

The Raman tilt measurement unit 17 measures the power of any measurement channel among the optical outputs extracted by the tap coupler 301. Here, for example, the power of the center channel (for example, the 51st channel) of the divided subbands described above in the second example embodiment may be measured. The measurement channel may span a plurality of channels, or may be a single channel, such as the first channel or the last channel.

### (Flatness Calculation Unit 18)

The flatness calculation unit 18 calculates the flatness based on the power of the measurement channel measured by the Raman tilt measurement unit 17. Here, after the equalizer correction of the node apparatus 101′ is performed, the actual Raman tilt (flatness) in any measurement channel is calculated.

### (Division Number Change Unit 19)

In a case where the flatness calculated by the flatness calculation unit 18 exceeds a predetermined threshold, the division number change unit 19 changes the number of divisions. This (wavelength) number of divisions affects the Raman tilt estimate accuracy. That is, when the number of divisions is reduced, accuracy of integration is reduced, and thus estimation accuracy is deteriorated. Meanwhile, if the number of divisions is increased, the calculation amount increases. Therefore, by the estimation method M30 described below, while measuring the flatness after the Raman tilt compensation by the equalizer 104, the measured value and the estimated value (estimation result PRED) are compared, and the number of divisions is updated so as to achieve the desired flatness, so that the calculation amount can be reduced while maintaining the estimation accuracy.

### (Effect of Node Apparatus 101′)

As described above, in the node apparatus 101′,
a configuration is adopted that includes:
   the above-described estimation apparatus;
   an optical transmission line that transmits an optical signal from an adjacent node;
   an optical amplifier that is connected to the optical transmission line and amplifies the optical signal;
   an equalizer that is connected to the optical amplifier and corrects the optical signal;
   a tap coupler that extracts a part of an optical output of the equalizer;
   an optical switch that is connected to the equalizer and switches a path of the optical signal;
   an optical transceiver that is connected to the optical switch and adds/drops a client signal to/from the optical switch;
   a device controller that controls the optical amplifier, the equalizer, the tap coupler, the optical switch, and the optical transceiver; and
   an equalizer adjustment means for correcting power of the plurality of subbands based on Raman tilt calculated in the Raman tilt calculation means.

Further, in the node apparatus 101′, a configuration is adopted that includes:
a Raman tilt measurement means for measuring power of any measurement channel among optical outputs extracted by the tap coupler;
a flatness calculation means for calculating flatness based on power of the measurement channel measured by the Raman tilt measurement unit; and
a division number change means for changing the number of divisions in a case where the calculated flatness exceeds a predetermined threshold.

Therefore, calculation amount can be reduced while maintaining estimation accuracy. In other words, optimized and faster Raman tilt estimation and compensation is possible.

### (Flow of Estimation Method M30)

Next, a flow of the estimation method M30 according to the present exemplary example embodiment will be described with reference to FIG. 5. FIG. 5 is a flowchart illustrating a flow of the estimation method M30. The estimation method M30 includes a step S30 of generating a trigger, a step S31 of acquiring each wavelength use state and optical power, a step S32 of determining the number of divisions, a step S33 of calculating a Raman tilt, a step S34 of holding the calculated Raman tilt, a step S35 of adjusting with an equalizer, a step S36 of extracting a part of an equalizer output, a step S37 of calculating flatness of the Raman tilt, a step S37 of calculating flatness, a step S38 of comparing the flatness with a predetermined threshold, and a step S39 of changing the number of divisions.

### (Step S30)

In step S30, the generation unit 14 generates a trigger for calculating the Raman tilt amount. Since a more specific description of the generation unit 14 has been described above, the description thereof will be omitted here.

### (Step S31)

In step S31, the acquisition unit 11 refers to the optical path information database LPI to acquire the wavelength use state in the optical transmission line 102 and the optical power of each use wavelength at the adjacent node outlet of the optical transmission line 102. Since a more specific description of the acquisition unit 11 has been described above, the description thereof will be omitted here.

### (Step S32)

In step S32, the determination unit 12 determines the number of divisions for dividing the entire use band into a plurality of subbands. Since a more specific description of the determination unit 12 has been described above, the description thereof will be omitted here.

### (Step S33)

In step S33, the Raman tilt calculation unit 13 (23) estimates (calculates) the Raman tilt by using an integral expression in which each of subbands obtained by dividing the entire use band into the number of divisions is an integration step, the subbands having, as parameters, a use state of each of the use wavelengths, optical power of each of the use wavelengths, a loss coefficient determined by a fiber type of the optical transmission line, a link distance defining a distance between adjacent nodes, and a Raman coefficient. As described above, assuming that power is intensively arranged in the center channel (for example, the 51st channel) of the divided subbands, the Raman tilt calculation unit 23 (13) may calculate the Raman tilt using Expression (4) for the central subband of the plurality of subbands. Since a more specific description of the Raman tilt calculation unit 23 (13) has been described above, the description thereof is omitted here.

### (Step S34)

In step S34, the holding unit 15 holds the Raman tilt calculated by the Raman tilt calculation unit 23 in the Raman tilt information database RTI. The latest calculation result is also stored in the estimation result PRED of the storage unit 20. Since a more specific description of the holding unit 15 has been described above, the description thereof will be omitted here.

### (Step S35)

In step S35, the equalizer adjustment unit 16 corrects the power of the plurality of subbands based on the Raman tilt calculated by the Raman tilt calculation unit 23. Since the more specific description regarding the equalizer adjustment unit 16 has been described above, the description thereof will be omitted here.

### (Step S36)

In step S36, the Raman tilt measurement unit 17 measures the power of any measurement channel among the optical outputs extracted by the tap coupler 301. Since a more specific description of the Raman tilt measurement unit 17 has been described above, the description thereof is omitted here.

### (Step S37)

In step S37, the flatness calculation unit 18 calculates (actual) flatness (Raman tilt) based on the power of the measurement channel measured by the Raman tilt measurement unit 17. More specific description of the flatness calculation unit 18 has been described above, and thus description thereof will be omitted here.

### (Step S38)

In step S38, the control unit 10 compares whether the flatness calculated by the flatness calculation unit 18 exceeds a predetermined threshold. This predetermined threshold corresponds to a compensation target value of the Raman tilt (inclination), and is specifically 0.10, 0.25, 0.50, or the like. In a case of “Yes” in step S38, the process proceeds to step S39, and in a case of “No”, the process of the estimation method M30 is completed.

### (Step S39)

In a case where the flatness calculated by the flatness calculation unit 18 exceeds a predetermined threshold, the division number change unit 19 changes the number of divisions in step S39. Since a more specific description of the division number change unit 19 has been described above, the description thereof will be omitted here. When the process in step S39 is completed, the process returns to step S33, and one loop is formed in steps S33 to S39. This control loop is configured such that the flatness calculated by the flatness calculation unit 18 falls within a predetermined threshold or less.

As described above, in the estimation method M30, a configuration is adopted that includes: measuring power of any measurement channel among the optical outputs extracted by the tap coupler; calculating flatness based on the power of the measurement channel measured by the Raman tilt measurement unit; and changing the number of divisions in a case where the calculated flatness exceeds a predetermined threshold. According to the above configuration, an effect similar to that of the node apparatus 101′ is obtained.

### Fourth Example Embodiment

A fourth exemplary example embodiment which is an example of an example embodiment of the present disclosure will be described in detail with reference to the drawings. Components having the same functions as the components described in the above-described exemplary example embodiments are denoted by the same reference signs, and the description thereof will be appropriately omitted. The application range of each technique adopted in the present exemplary example embodiment is not limited to the present exemplary example embodiment. That is, each technique adopted in the present exemplary example embodiment can also be adopted in other exemplary example embodiments included in the present disclosure as long as no particular technical problem occurs. Each technique illustrated in each drawing referred to for explaining the present exemplary example embodiment can also be employed in other exemplary example embodiments included in the present disclosure as long as no particular technical problem occurs.

### (Configuration of Optical Network System)

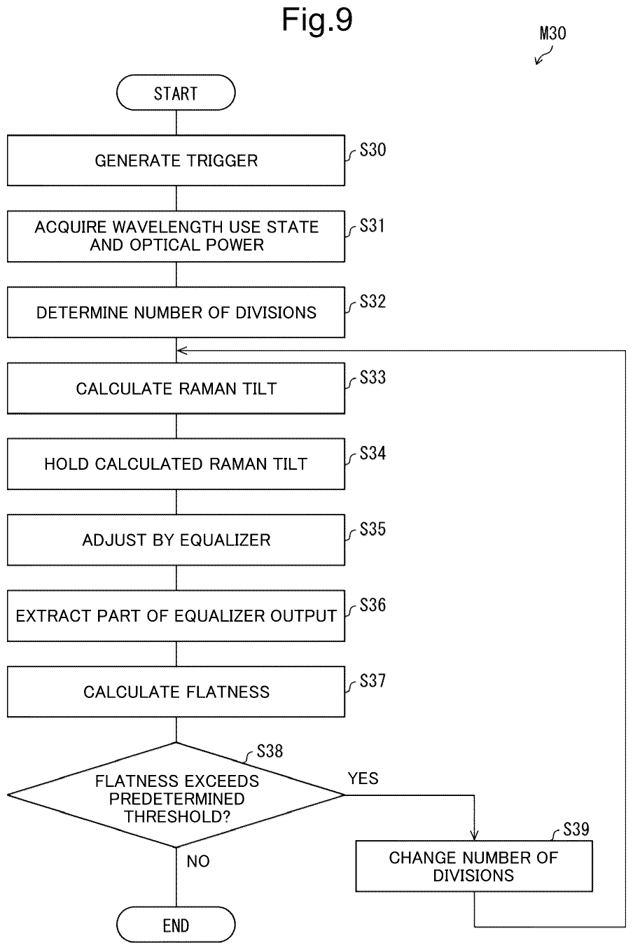

A configuration of an optical network system (NMS) 401 according to the present exemplary example embodiment will be described with reference to FIG. 10. The optical network system 401 includes a plurality of the above-described node apparatuses 101′ (101) connected by the optical transmission lines 102, and controls the plurality of node apparatuses 101′ (101). Here, each node apparatus 101′ may be a reception node that receives data from the NMS 401 or an adjacent node outlet in the optical transmission line 102, or may be a transmission node that transmits data to the adjacent node inlet or the NMS 401.

The predetermined threshold (the compensation target value of the Raman tilt (inclination)) in each node apparatus 101′ may be uniformly determined, or may be changed by the role of each node apparatus (for example, a node apparatus specialized for transmission serving as a server and a node apparatus specialized for reception serving as a client).

With the configuration as described above, it is possible to reduce the calculation amount while maintaining the estimation accuracy of the entire system, and the transmission efficiency of the entire system is improved. In other words, it is possible to provide a technique that enables optimized and faster Raman tilt estimation and compensation.

### [Implementation Example by Software]

Some or all of the functions of the estimation apparatuses 1 and 109, the node apparatuses 101 and 101′, and the NMS 401 (hereinafter, also referred to as “each of the above apparatuses”) may be achieved by hardware such as an integrated circuit (IC chip) or may be achieved by software.

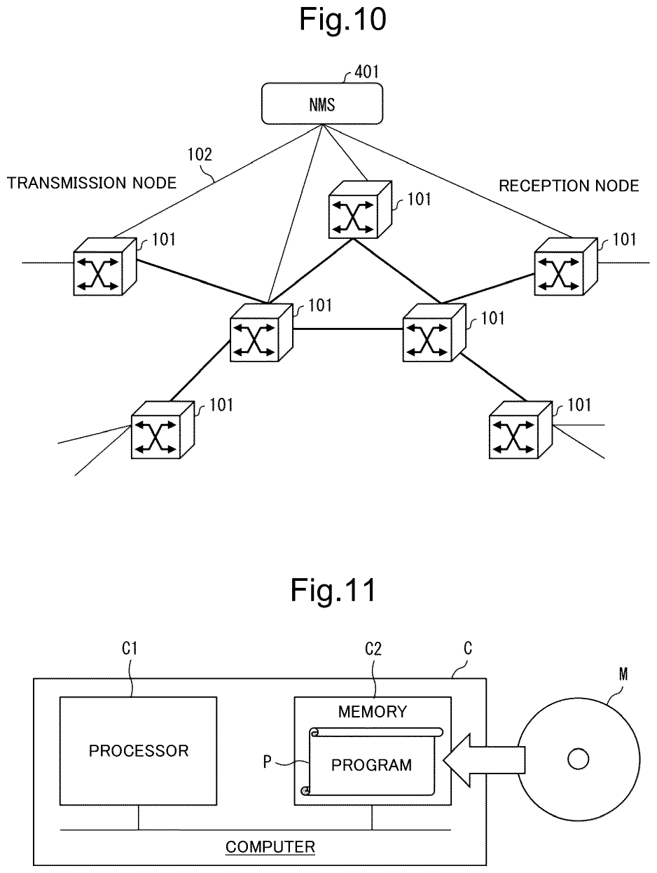

In the latter case, each of the above-described apparatuses is achieved by, for example, a computer that executes a command of a program that is software for achieving each function. An example of such a computer (hereinafter, referred to as a computer C) is illustrated in FIG. 11. FIG. 11 is a block diagram illustrating a hardware configuration of a computer C functioning as each of the above apparatuses.

The computer C includes at least one processor C1 and at least one memory C2. A program P for operating the computer C as each of the above apparatuses is recorded in the memory C2. In the computer C, the processor C1 reads the program P from the memory C2 and executes the program P to implement each function of each of the above-described apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination thereof, or the like can be used. As the memory C2, for example, a flash memory, a hard disk drive (HDD), a solid state drive (SSD), a combination thereof, or the like can be used.

The computer C may further include a random access memory (RAM) for loading the program P at the time of execution and temporarily storing various data. The computer C may further include a communication interface for transmitting and receiving data to and from another apparatus. The computer C may further include an input/output interface for connecting input/output equipment such as a keyboard, a mouse, a display, and a printer.

The program P can be recorded on a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### [Supplementary Note A]

The present disclosure includes the techniques described in the following supplementary notes. However, the present disclosure is not limited to the techniques described in the following supplementary notes, and various modifications can be made within the scope described in the claims.

### (Supplementary Note A1)

An estimation apparatus that estimates a Raman tilt of an optical transmission line in an all-photonics network,
the estimation apparatus including:
an acquisition means for acquiring a use state of each use wavelength in the optical transmission line and optical power of each use wavelength at an outlet of an adjacent node of the optical transmission line;
a determination means for determining the number of divisions; and
a Raman tilt calculation means for estimating the Raman tilt by using an integral expression in which each of subbands obtained by dividing an entire use band into the number of divisions is an integration step, the subbands having, as parameters, a use state of each use wavelength, optical power of each use wavelength, a loss coefficient determined by a fiber type of the optical transmission line, a link distance defining a distance between adjacent nodes, and a Raman coefficient.

### (Supplementary Note A2)

The estimation apparatus according to Supplementary Note A1, further including
a holding means for holding the Raman tilt calculated.

### (Supplementary Note A3)

A node apparatus including:
an estimation apparatus according to Supplementary Note A1 or A2;
an optical transmission line that transmits an optical signal from an adjacent node;
an optical amplifier that is connected to the optical transmission line and amplifies the optical signal;
an equalizer that is connected to the optical amplifier and corrects the optical signal;
a tap coupler that extracts a part of optical output of the equalizer;
an optical switch that is connected to the equalizer and switches a path of the optical signal;
an optical transceiver that is connected to the optical switch and adds/drops a client signal to/from the optical switch; and
a device controller that controls the optical amplifier, the equalizer, the tap coupler, the optical switch, and the optical transceiver.

### (Supplementary Note A4)

The node apparatus according to Supplementary Note A3, further including
an equalizer adjustment means for correcting power of the plurality of subbands based on the Raman tilt calculated by the Raman tilt calculation means.

### (Supplementary Note A5)

The node apparatus according to Supplementary Note A4, further including:
a Raman tilt measurement means for measuring power of any measurement channel among optical outputs extracted by the tap coupler; and
a flatness calculation means for calculating flatness based on the power of the measurement channel measured by the Raman tilt measurement means.

### (Supplementary Note A6)

The node apparatus according to Supplementary Note A5, further including
a division number change means for changing the number of divisions in a case where the flatness calculated exceeds a predetermined threshold.

### (Supplementary Note A7)

An optical network system including:
a plurality of node apparatuses according to Supplementary Note A3, wherein the optical network system controls the plurality of node apparatuses.

### [Supplementary Note B]

The present disclosure includes the techniques described in the following supplementary notes. However, the present disclosure is not limited to the techniques described in the following supplementary notes, and various modifications can be made within the scope described in the claims.

### (Supplementary Note B1)

An estimation method for estimating a Raman tilt of an optical transmission line in an all-photonics network, the estimation method including:
an acquisition process of acquiring, by at least one processor, a use state of each use wavelength in the optical transmission line and optical power of each use wavelength at an outlet of an adjacent node of the optical transmission line;
a determination process of determining, by the at least one processor, the number of divisions; and
a Raman tilt calculation process of estimating, by the at least one processor, the Raman tilt by using an integral expression in which each of subbands obtained by dividing an entire use band into the number of divisions is an integration step, the subbands having, as parameters, a use state of each use wavelength, optical power of each use wavelength, a loss coefficient determined by a fiber type of the optical transmission line, a link distance defining a distance between adjacent nodes, and a Raman coefficient.

### (Supplementary Note B2)

The estimation method according to Supplementary Note B1, further including
a holding process of holding the Raman tilt calculated by the at least one processor.

### (Supplementary Note B3)

The estimation method according to Supplementary Note B2, further including
an equalizer adjustment process of correcting, by the at least one processor, power of the plurality of subbands based on the Raman tilt calculated by the Raman tilt calculation process.

### (Supplementary Note B4)

The estimation method according to Supplementary Note B3, further including:
a Raman tilt measurement process of measuring, by the at least one processor, power of any measurement channel among optical outputs extracted by the tap coupler; and
a flatness calculation process of calculating, by the at least one processor, flatness based on the power of the measurement channel measured by the Raman tilt measurement unit.

### (Supplementary Note B5)

The estimation method according to Supplementary Note B4, further including
a division number change process of changing, by the at least one processor, the number of divisions in a case where the flatness calculated exceeds a predetermined threshold.

### [Supplementary Note C]

The present disclosure includes the techniques described in the following supplementary notes. However, the present disclosure is not limited to the techniques described in the following supplementary notes, and various modifications can be made within the scope described in the claims.

### (Supplementary Note C1)

An estimation program for causing a computer to function as an estimation apparatus that estimates a Raman tilt of an optical transmission line in an all-photonics network,
the estimation program causing the computer to function as:
an acquisition means for acquiring a use state of each use wavelength in the optical transmission line and optical power of each use wavelength at an outlet of an adjacent node of the optical transmission line;
a determination means for determining the number of divisions; and
a Raman tilt calculation means for estimating the Raman tilt by using an integral expression in which each of subbands obtained by dividing an entire use band into the number of divisions is an integration step, the subbands having, as parameters, a use state of each use wavelength, optical power of each use wavelength, a loss coefficient determined by a fiber type of the optical transmission line, a link distance defining a distance between adjacent nodes, and a Raman coefficient.

### (Supplementary Note C2)

The estimation program according to Supplementary Note C1,
the estimation program causing the computer to further function as
a holding means for holding the Raman tilt calculated.

### (Supplementary Note C3)

A node program including:
the estimation apparatus according to Supplementary Note C1 or C2;
an optical transmission line that transmits an optical signal from an adjacent node;
an optical amplifier that is connected to the optical transmission line and amplifies the optical signal;
an equalizer that is connected to the optical amplifier and corrects the optical signal;
a tap coupler that extracts a part of optical output of the equalizer;
an optical switch that is connected to the equalizer and switches a path of the optical signal;
an optical transceiver that is connected to the optical switch and adds/drops a client signal to/from the optical switch; and
a device controller that controls the optical amplifier, the equalizer, the tap coupler, the optical switch, and the optical transceiver.

### (Supplementary Note C4)

The node program according to Supplementary Note C3,
the node program causing the computer to further function as
an equalizer adjustment means for correcting power of the plurality of subbands based on the Raman tilt calculated by the Raman tilt calculation means.

### (Supplementary Note C5)

The node program according to Supplementary Note C4,
the node program causing the computer to further function as
a Raman tilt measurement means for measuring power of any measurement channel among optical outputs extracted by the tap coupler; and
a flatness calculation means for calculating flatness based on the power of the measurement channel measured by the Raman tilt measurement unit.

### (Supplementary Note C6)

The node program according to Supplementary Note C5,
the node program causing the computer to further function as
a division number change means for changing the number of divisions in a case where the flatness calculated exceeds a predetermined threshold.

### (Supplementary Note C7)

An optical network program including
a plurality of node programs according to Supplementary Note C3, wherein the optical network program controls the plurality of node programs.

### [Supplementary Note D]

The present disclosure includes the techniques described in the following supplementary notes. However, the present disclosure is not limited to the techniques described in the following supplementary notes, and various modifications can be made within the scope described in the claims.

### (Supplementary Note D1)

An estimation apparatus that estimates a Raman tilt of an optical transmission line in an all-photonics network, the estimation apparatus including:
at least one processor, the at least one processor executing:
an acquisition process of acquiring a use state of each use wavelength in the optical transmission line and optical power of each use wavelength at an outlet of an adjacent node of the optical transmission line;
a determination process of determining the number of divisions; and
a Raman tilt calculation process of estimating the Raman tilt by using an integral expression in which each of subbands obtained by dividing an entire use band into the number of divisions is an integration step, the subbands having, as parameters, a use state of each use wavelength, optical power of each use wavelength, a loss coefficient determined by a fiber type of the optical transmission line, a link distance defining a distance between adjacent nodes, and a Raman coefficient.

The estimation apparatus may further include a memory. The memory may store a program for causing the at least one processor to execute each process.

### (Supplementary Note D2)

The estimation apparatus according to Supplementary Note D1, wherein
the at least one processor further executes
a holding process of holding the Raman tilt calculated.

### (Supplementary Note D3)

A node apparatus including:
an estimation apparatus according to Supplementary Note D1 or D2;
an optical transmission line that transmits an optical signal from an adjacent node;
an optical amplifier that is connected to the optical transmission line and amplifies the optical signal;
an equalizer that is connected to the optical amplifier and corrects the optical signal;
a tap coupler that extracts a part of optical output of the equalizer;
an optical switch that is connected to the equalizer and switches a path of the optical signal;
an optical transceiver that is connected to the optical switch and adds/drops a client signal to/from the optical switch; and
a device controller that controls the optical amplifier, the equalizer, the tap coupler, the optical switch, and the optical transceiver.

### (Supplementary Note D4)

The node apparatus according to Supplementary Note D3, wherein
the at least one processor further executes
an equalizer adjustment process of correcting power of the plurality of subbands based on the Raman tilt calculated by the Raman tilt calculation process.

### (Supplementary Note D5)

The node apparatus according to Supplementary Note D4, wherein
the at least one processor further executes:
a Raman tilt measurement process of measuring power of any measurement channel among optical outputs extracted by the tap coupler; and
a flatness calculation process of calculating flatness based on the power of the measurement channel measured by the Raman tilt measurement unit.

### (Supplementary Note D6)

The node apparatus according to Supplementary Note D5, wherein
the at least one processor further executes
a division number change process of changing the number of divisions in a case where the flatness calculated exceeds a predetermined threshold.

### (Supplementary Note D7)

An optical network system including:
a plurality of node apparatuses according to Supplementary Note D3, wherein the optical network system controls the plurality of node apparatuses.

### [Supplementary Note E]

The present disclosure includes the techniques described in the following supplementary notes. However, the present disclosure is not limited to the techniques described in the following supplementary notes, and various modifications can be made within the scope described in the claims.

### (Supplementary Note E1)

A non-transitory recording medium storing an estimation program for causing a computer to function as an estimation apparatus that estimates a Raman tilt of an optical transmission line in an all-photonics network,
the program causing the computer to execute:
an acquisition process of acquiring a use state of each use wavelength in the optical transmission line and optical power of each use wavelength at an outlet of an adjacent node of the optical transmission line;
a determination process of determining the number of divisions; and
a Raman tilt calculation process of estimating the Raman tilt by using an integral expression in which each of subbands obtained by dividing an entire use band into the number of divisions is an integration step, the subbands having, as parameters, a use state of each use wavelength, optical power of each use wavelength, a loss coefficient determined by a fiber type of the optical transmission line, a link distance defining a distance between adjacent nodes, and a Raman coefficient.

1. An estimation apparatus that estimates a Raman tilt of an optical transmission line in an all-photonics network, the estimation apparatus comprising:
an acquisition circuit configured to acquire a use state of each use wavelength in the optical transmission line and optical power of each use wavelength at an outlet of an adjacent node of the optical transmission line;
a determination circuit configured to determine the number of divisions; and
a Raman tilt calculation circuit configured to estimate the Raman tilt by using an integral expression in which each of subbands obtained by dividing an entire use band into the number of divisions is an integration step, the subbands having, as parameters, a use state of each use wavelength, optical power of each use wavelength, a loss coefficient determined by a fiber type of the optical transmission line, a link distance defining a distance between adjacent nodes, and a Raman coefficient.

2. The estimation apparatus according to claim 1, further comprising
a holding circuit configured to hold the Raman tilt calculated.

3. A node apparatus comprising:
an estimation apparatus according to claim 1;
an optical transmission line that transmits an optical signal from an adjacent node;
an optical amplifier that is connected to the optical transmission line and amplifies the optical signal;
an equalizer that is connected to the optical amplifier and corrects the optical signal;
a tap coupler that extracts a part of optical output of the equalizer;
an optical switch that is connected to the equalizer and switches a path of the optical signal;
an optical transceiver that is connected to the optical switch and adds/drops a client signal to/from the optical switch; and
a device controller that controls the optical amplifier, the equalizer, the tap coupler, the optical switch, and the optical transceiver.

4. The node apparatus according to claim 3, further comprising
an equalizer adjustment circuit configured to correct power of the plurality of subbands based on the Raman tilt calculated by the Raman tilt calculation circuit.

5. The node apparatus according to claim 4, further comprising:
a Raman tilt measurement circuit configured to measure power of any measurement channel among optical outputs extracted by the tap coupler; and
a flatness calculation circuit configured to calculate flatness based on the power of the measurement channel measured by the Raman tilt measurement circuit.

6. The node apparatus according to claim 5, further comprising
a division number change circuit configured to change the number of divisions in a case where the flatness calculated exceeds a predetermined threshold.

7. An estimation method for estimating a Raman tilt of an optical transmission line in an all-photonics network, the estimation method comprising:
an acquisition process of acquiring, by at least one processor, a use state of each use wavelength in the optical transmission line and optical power of each use wavelength at an outlet of an adjacent node of the optical transmission line;
a determination process of, by the at least one processor, determining the number of divisions; and
a Raman tilt calculation process of, by the at least one processor, estimating the Raman tilt by using an integral expression in which each of subbands obtained by dividing an entire use band into the number of divisions is an integration step, the subbands having, as parameters, a use state of each use wavelength, optical power of each use wavelength, a loss coefficient determined by a fiber type of the optical transmission line, a link distance defining a distance between adjacent nodes, and a Raman coefficient.

8. The estimation method according to claim 7, further comprising
a holding process of holding the Raman tilt calculated by the at least one processor.

9. The estimation method according to claim 8, further including
an equalizer adjustment process of correcting, by the at least one processor, power of the plurality of subbands based on the Raman tilt calculated by the Raman tilt calculation process.

10. The estimation method according to claim 9, further including:
a Raman tilt measurement process of measuring, by the at least one processor, power of any measurement channel extracted from optical output of the equalizer adjustment process; and
a flatness calculation process of calculating, by the at least one processor, flatness based on the power of the measurement channel measured by the Raman tilt measurement unit.

11. The estimation method according to claim 10, further including
a division number change process of changing, by the at least one processor, the number of divisions in a case where the flatness calculated exceeds a predetermined threshold.

12. An optical network system comprising
a plurality of node apparatuses according to claim 3, wherein the optical network system controls the plurality of node apparatuses.

13. A non-transitory recording medium storing an estimation program for causing a computer to function as an estimation apparatus that estimates a Raman tilt of an optical transmission line in an all-photonics network,
the program causing the computer to execute:
an acquisition process of acquiring a use state of each use wavelength in the optical transmission line and optical power of each use wavelength at an outlet of an adjacent node of the optical transmission line;
a determination process of determining the number of divisions; and
a Raman tilt calculation process of estimating the Raman tilt by using an integral expression in which each of subbands obtained by dividing an entire use band into the number of divisions is an integration step, the subbands having, as parameters, a use state of each use wavelength, optical power of each use wavelength, a loss coefficient determined by a fiber type of the optical transmission line, a link distance defining a distance between adjacent nodes, and a Raman coefficient.
